(19) United States
(12) Patent Application Publication
(10) Pub. No.: US 2020/0044888 A1
(43) Pub. Date: Feb. 6, 2020

(54) SMART HOME SYSTEM

(71) Applicant: DNG TECHNOLOGIES LTD., Tel Aviv (IL)

(72) Inventors: Gabriel MANRICKS, Tel Aviv (IL); Dor ARAD, Tel Aviv (IL); Nitzan BLANKLEDER, Tel Aviv (IL)

(21) Appl. No.: 15/738,581

(22) PCT Filed: Jun. 22, 2016
(86) PCT No.: PCT/IL2016/050665

§ 371 Date: Dec. 21, 2017

Related U.S. Application Data
(60) Provisional application No. 62/182,663, filed on Jun. 22, 2015.

(51) Int. Cl. H04L 12/28; H04W 28/02; H04W 84/18; H04L 12/751; H04W 8/00; H04W 72/12

(52) U.S. Cl. CPC H04L 12/2838; H04W 28/0231; H04L 12/282; H04L 2012/2841; H04L 45/02; H04W 8/005; H04W 72/1242; H04W 84/18

(57) ABSTRACT

A method for managing transmission priority of data transmission from a base node in a mesh network, having a plurality of neighboring nodes, to a destination, is provided. The method includes receiving data at the base node the data including execution data and destination data, the destination data being related to the destination of the execution data; transmitting the data from the base node to each of the neighboring nodes, the transmitting can be carried out by a dedicated transmission mode for each of the neighboring nodes in an order determined in accordance with a transmission rating of each of the neighboring nodes, the transmission rating being related to previous transmissions; receiving at the base node a receipt acknowledgment from a neighboring node which successfully delivered the data to the destination; and adjusting the transmission rating of the neighboring node in accordance with the delivery acknowledgment.

### FIELD OF INVENTION

The presently disclosed subject matter relates to a smart home system controlling devices inside a designated area, in general, and in particular to smart home system configured for wireless communication and a method for managing same.

### BACKGROUND

Smart home systems, also known as home automation, is the residential extension of building automation and involves the control and automation of lighting, heating, ventilation, air conditioning (HVAC), appliances, and security. Modern systems generally consist of switches and sensors connected to a central hub sometimes called a “gateway” from which the system is controlled with a user interface that is interacted either with a wall mounted terminal, mobile phone software, tablet computer or a web interface.

US 20140098247 discloses A system and method for home control and automation including a smart home with control of devices and appliance using mobile devices, cellular telephones, smart devices and smart phones is described. The mobile device may download a software application configured to control an electrical switch or electrical power outlet. The mobile device may change the on or off state of the outlet or the power settings of the outlet. The mobile device may control other intelligent appliances including a television using a wireless connection. The electrical outlets may be enabled with a smart electrical switch that includes a wireless transmit and receive component such as WiFi. The electrical switch may be programmable and be identified with a unique identifier. The electrical outlets may include a sensor to detect smoke, temperature, light, pressure, or other factors. The mobile device and electrical switch may join the same wireless local area network.

US 20080040509 discloses a method and apparatus for communication in a wireless sensor network. In one embodiment, one or more routers in a network may be available for communication with one or more star nodes at a randomized time and/or frequency. A connectivity assessment, which may be performed at several different frequencies and/or times, may be performed to evaluate the quality of communications between devices in the network. Primary and secondary communication relationships may be formed between devices to provide for system redundancy. Node activity may be monitored, e.g., based on heartbeats sent from a node, to help ensure that nodes remain active. One or more proxies may be maintained where each proxy includes a status of one or more devices in the network, e.g., one or more star nodes or routers. Proxies may be used to handle information requests and/or status change requests, e.g., a proxy may be requested to change a communication relationship between devices in the network and may generate command signals to cause the corresponding devices to make the change.

### SUMMARY OF INVENTION

There is provided in accordance with an aspect of the presently disclosed subject matter a method for managing transmission priority of data transmission from a base node in a mesh network, having a plurality of neighboring nodes, to a destination. The method includes receiving data at the base node the data including execution data and destination data, the destination data being related to the destination of the execution data; transmitting the data from the base node to each of the neighboring nodes, the transmitting can be carried out by a dedicated transmission mode for each of the neighboring nodes in an order determined in accordance with a transmission rating of each of the neighboring nodes, the transmission rating being related to previous transmissions; receiving at the base node a receipt acknowledgment from a neighboring node which successfully delivered the data to the destination; and adjusting the transmission rating of the neighboring node in accordance with the delivery acknowledgment.

The destination can be a controller in the mesh network configured to control a device, and wherein the execution data includes data to be executed by the device.

The transmission mode can be a frequency, and wherein each of the neighboring nodes can be configured to receive said data in a unique frequency with respect to other neighboring nodes.

The node can be configured to transmit said data to each of said neighboring nodes in a dedicated frequency.

The node transmits first the data to one of the neighboring nodes having the highest rating with respect to ratings of other neighboring nodes.

The receipt acknowledgment can be generated by the destination, when the data reaches the destination.

The receipt acknowledgment includes identification of the destination.

The adjusting can includes upgrading the transmission rating for a neighboring node from which the receipt acknowledgment can be received first for each data transmission.

The adjusting can further include downgrading the transmission rating for a neighboring node from which no receipt acknowledgment is received.

There is provided in accordance with a further aspect of the presently disclosed subject matter a smart home system for integration in a designated area. The system includes a plurality of transceiver units each of which configured to be disposed in a location around the designated area and to form with one another a mesh communication network, such that each one of the transceiver units has at least one neighboring transceiver unit. Wherein each one of the transceiver units is configured to receive data in a first transmission mode and to transmit the data in at least a second transmitting mode and wherein the at least one neighboring transceiver unit is configured to receive data in the second transmitting mode.

The transceiver unit can include a first neighboring transceiver unit configured to received data in the second transmission mode, and a second neighboring transceiver unit configured to received data in a third transmission mode, and wherein the transceiver unit can be configured to selectively transmit the data in at least the second transmitting mode and the third transmitting mode.

The first and second transmitting modes are distinct from one another and configured to reduce transmission interference with one another.

The smart home system can further include at least one controller configured for controlling an electric device in the designated area, the controller being configured to receive data from at least one of the transceiver unit. The at least one controller can be integrated in the electric devices. The at least one controller can be integrally formed with one of the transducing units.

Each one of the transceiver units can be integrated in an electric element mounted in the designated area. The electric element can be an electric socket or switch.

The smart home system can further include a hub configured to exchange data with a remote device. The hub can be further configured to allow receiving and storing data related to the electric device in a cloud.

There is provided with yet another aspect of the presently disclosed subject matter a smart home system for integration in a designated area. The system includes a plurality of transceiver units each of which configured to be disposed in a location around the designated area and to form with one another a mesh communication network, such that each one of the transceiver units has at least two neighboring transceiver units; wherein each one of the transceiver units is configured to receive data in a first transmission mode, the data including execution data and destination data, the destination data being related to a destination of the execution data in the mesh communication network; wherein each one of the transceiver units is further configured to transmit the data to each of the at least two neighboring transceiver units in a transmission mode dedicated for each of the two neighboring transceiver units; wherein transmission to the two neighboring transceiver units is carried out in an order determined in accordance with a transmission rating of each of the neighboring transceiver units; and wherein the transceiver units is configured to adjust the transmission rating in accordance with previous successful transmission to the destination via the neighboring transceiver units.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a schematic view of a designate area having smart home system installed therein in accordance with an example of the presently disclosed subject matter;

FIG. 2 is a schematic view of a data transmission of the smart home system of FIG. 1, and;

FIG. 3 is a flow diagram illustrating a method for managing transmission priority of data transmission between nodes in a mesh network, in accordance with an example of the presently disclosed subject matter.

### DETAILED DESCRIPTION OF EMBODIMENTS

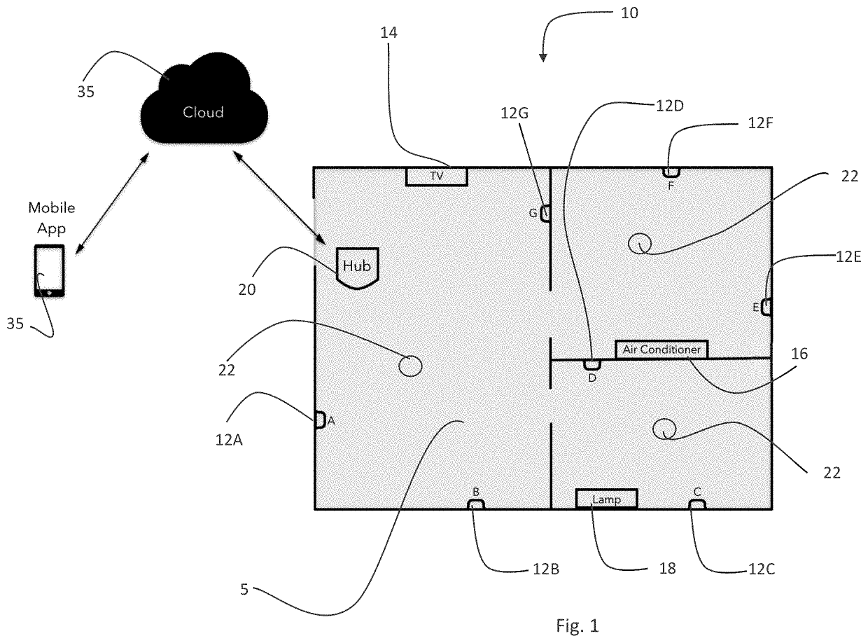

FIG. 1A shows a wireless smart home system 10, integrated in a designated area, here illustrated as an apartment 5, and having a plurality of transducing units 12A-12G, mounted in various locations around the apartment 5. The transducing units 12A-12G, are configured to wirelessly communicate with one another and to form thereby a mesh communication network. The system 10 further includes controllers 22 for controlling electric devices, such as a TV sets 14, AC unit 16 and a lamp 18, etc. According to an example, each room in the apartment can be provided with a controller 22 configured for controlling one or more electric devices in the room or in close proximity thereto, and for communicating with one or more of the transducing units 12A-12G.

According to a further example, the controllers are integrated in the electric devices, and configured for communication with at least one of the transducing units 12A-12G, such that the electric devices can be controlled via the mesh communication network. According to another example the controllers are integrally formed with some of the transducing units 12A-12G and configured for wirelessly communicating with one or more electric devices, for example via IR data transmission.

According to an example, the transceiver units 12A-12G are integrated in electric elements in the designated area, such as electric switches and sockets, smoke detectors, alarm sensors, light fixtures and other utility device. That is to say, instead of mounted a transceiver units around the apartment 5, switches and sockets, which are already mounted in strategic locations around the apartment, can include a transceiver unit integrally formed therewith, such that the designated area includes a plurality of transceiver units. The transceiver units are disposed such that each transceiver units is in a distance from other transceiver units configured to allow communication therewith.

According to an example the switches and sockets in the apartment 5 are configured for smart home system, i.e. are configured as controllers and can control the power supply to electric devices coupled thereto. For example, a switch can be configured to automatically turn on and off the light in a specific location in the apartment. The transceiver unit integrated in the switch receives data requests through the mesh network directed to the switch which in response turns on or off the light. Similarly, a socket in the apartment can be configured to automatically control the power supply to electric devices coupled thereto, such as a fan or a lamp. The transceiver unit integrated in the socket receives data requests through the mesh network directed to the socket which in response turns on or off the devices coupled thereto

The system 10 further includes a hub 20 configured to exchange data with a remote device 30, out of the mesh network, such as via the internet and to transfer data to the transducing units 12A-12G in the mesh network. For example, the hub 20 can be configured to relay to all the transducing units in the mesh network, via neighboring transducing units 12A, 12B and 12G. Thus, the hub 20 allows controlling various electric devices in the apartment 5, via a remote device, such as a handheld device outside the apartment.

The hub 20 is further configured to allow receiving and storing data in a cloud 35, such as controlling protocols of various devices, statistical data received from the electric devices, or the transducing units 12A-12G related to usage of the electric devices. The hub 20 can further be configured to receive data from an outside source, such as weather data, and any other data which may contribute to the efficiency and operation of the electric devices coupled to the smart home system 10.

According to an example, the hub 20 can be configured to store all the necessary information for the operation of the mesh network, such that in case of communication failure with the cloud, the operation of the smart home system 10 is not interrupted.

In the event a new device is added to the smart home system 10 the controller 22 in the mesh network, which is in close proximity to the new electric device, can be sent the setting configuration of the new device, so as to allow controlling thereof. The hub 20 can thus be configured to store setting configurations of multiple electric devices, and to automatically recognize the new device, such that the required configuration protocol is sent to the controller associated with the new device. The hub 20 can be further configured to access the internet and to download drivers, and other setting protocols of devices in the smart home system, such as drivers and configuration protocol which are not stored in the hub 20 or updates to existing protocols.

The smart home system 20 thus allows controlling of multiple electric device in the apartment 5 via a remote device 30.

According to an aspect of the presently disclosed subject matter each of the transceiver units 12A-12G is configured to transmit data in at least a first transmitting mode and a second transmitting mode. That is to say, each transceiver units 12A-12G can be configured for example to transfer data in various modes, such as various frequencies, or encoding, etc. This way, each transceiver units can communicate with each of the neighboring units thereof in designated mode, eliminating thereby signal interference of the wireless communication.

According to an example, each one of the transceiver units 12A-12G is configured to receive data in one transmitting mode, and to transmit data in more than one mode, which is different than the transmission mode in which the transceiver units receives data. For the sake of simplicity the following description refers to a single transceiver units, for example, transceiver unit 12D, the explanation is true however to all the transceiver units in the mesh network.

The transceiver unit 12D is configured to receive data from neighboring transceiver unit 12B and 12C in a first transmitting mode, for example, a certain frequency. Each of the neighboring transceiver unit 12B and 12C, however, is configured to receive data in other transmitting modes, such that transceiver unit 12B is configured to receive data in a second frequency and transceiver unit 12C is configured to receive data in a third frequency. This way, each transceiver units received only data designated to this unit, while data transmitted in other frequencies is ignored.

In order for transceiver unit 12D to be able to relay data to its neighboring transceiver unit 12B and 12C, transceiver unit 12D is configured to transmit the data to its neighboring transceiver units 12B and 12C in the second and third frequencies, respectively. Thus, the data can be transmitted from the transceiver unit 12D only to the desired neighboring transceiver units 12B or 12C, eliminating thereby interference, and controlling the data flow within the mesh network.

According to an example, the transceiver unit 12D can be configured to relay the received data to both neighboring transceiver units 12B and 12C. Since each one of the neighboring transceiver units 12B and 12C is configured to receive data in a specific mode, such as a specific frequency range, the transceiver unit 12D transmit the data in both the first and second frequencies one after the other, such that the data is transmitted to both transceiver units 12B and 12C. Similarly, each one of the transceiver units 12A-12G in the system 10 is configured to receive data in one mode and relay the data to its neighboring transceiver units in various modes, such as frequencies, such that each one of the neighboring transceiver units receives the data, however in a dedicated transmission.

It is appreciated that although each one of the transceiver units 12A-12G is configured to receive data in a dedicated transmission mode, the transmission mode need not be unique with respect to all the other transceiver units in the mesh network, rather the transmission mode, such as the frequency is unique with respect to the neighboring transceiver units. This way, interference, which typically occur between transceiver units in close proximity to one another, is precluded, while the data is transmitted through all the transceiver units in the mesh network.

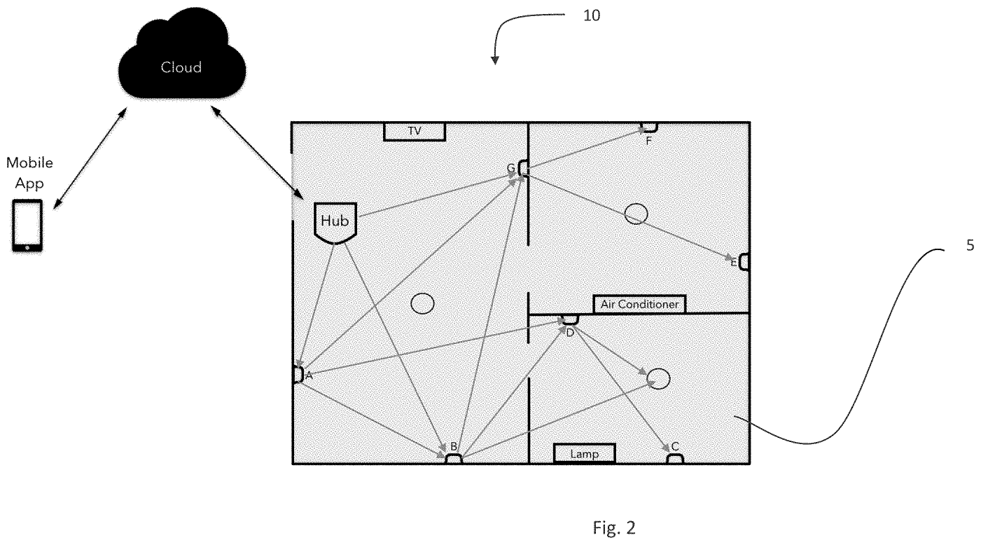

As shown in FIG. 2, according to an example, in case user wishes to have the lamp 18 be turned on in the apartment 5, a request can be initiated through the remote device 30, such as a mobile device equipped with a designated application or having access to a web application. The request is transmitted to a cloud 35 which directs the request the hub 20 associated with the handheld device 30 or with the user by a unique identification. The hub 20 of the smart home system 10 relays the message to the transceiver units 12A, 12B and 12G which are in close proximity thereto.

It is appreciated that the term ‘close proximity’ can be determined in accordance with the characteristics of the transmission protocol and the number of transceiver units in the designated area of the smart home system 10. That is to say, the transceiver units 12A-12G can be configured such that each unit is detected by neighboring transceiver units within a predetermined range or which can receive signal having a predetermined strength. This way, an efficient communication between the transceiver units, and communication between transceiver units which do not allow reliable data transmission is precluded.

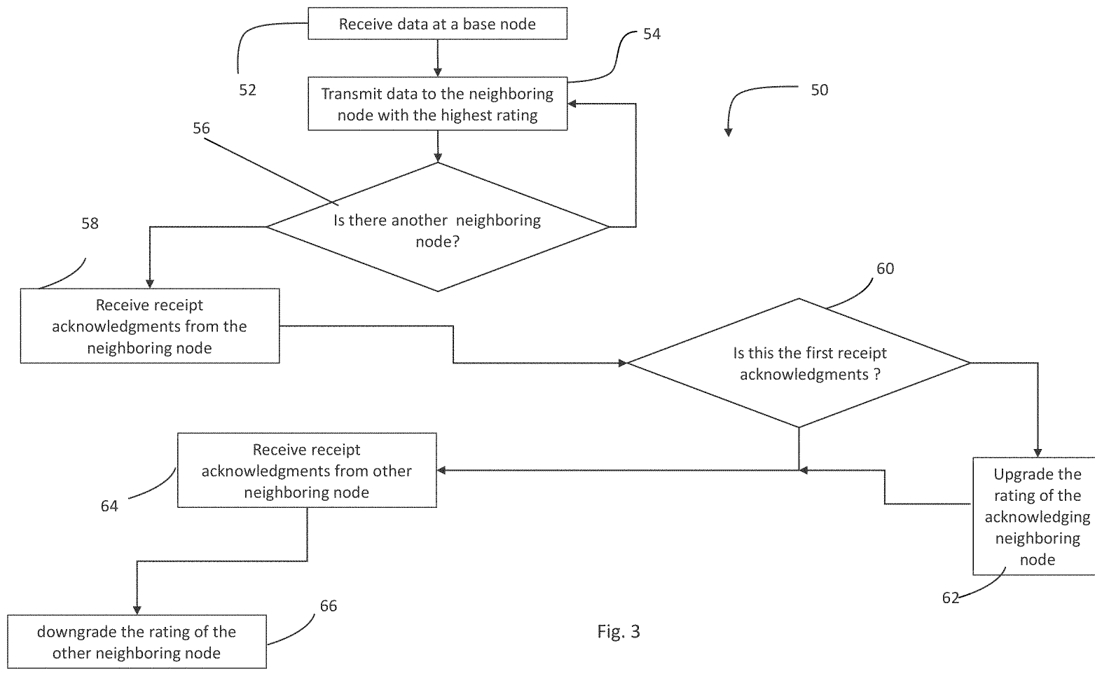

Referring back to FIG. 2, since each one of transceiver units 12A, 12B and 12G is configured to receive data in a unique frequency, the hub 20 transmits the request to each one of the transceiver units 12A, 12B and 12G in three distinct frequency ranges one after the other. The order in which the data is transmitted to the units 12A, 12B and 12G can be determined in accordance with the assumption which of the units 12A, 12B and 12G presents the highest probability to successfully relay the request to its final destination i.e. a controller 22 which can turn on the lamp 18. An example of method for determining the probability to successfully relay the request is described hereinafter with reference to FIG. 3.

Each one of the units 12A, 12B and 12G receives the request from the hub 20 and relays the request further to its neighboring units. That is to say, transceiver units 12A transmits the request to units 12B, 12G and 12D, transceiver units 12G transmits the request to units 12F and 12E, and so on. As in the previous step, each transceiver unit transmits the request to the neighboring transceiver units in multiple frequencies in accordance with the receiving frequency of each of the neighboring transceiver units thereof.

Finally, one of the transceiver units mounted in close proximity to the controller 22, i.e. transceiver units 12D and 12C, receives the request and relay the latter to the controller 22 which executes the request and turns on the lamp 18. As the request reaches the final destination thereof, i.e. controller 22, a receipt acknowledgment is sent back from the controller 22 to each of the transceiver units from which the request was received. Each of the transceiver units which receives the receipt acknowledgment transmit a similar receipt acknowledgment to all the neighboring transceiver units thereof form which it received the request. This way, all the transceiver units which took part in relaying the request are notified that the request was reached at its final destination, i.e. the controller 22 which controls the lamp 18.

The data related to the receipt acknowledgment can be collected can maintained so as to more efficiently determine the path through which a future similar request should be relayed. Thus, the transmission priority, in which each of the transceiver units 12A-12G transmits similar future request to the neighboring transceiver units thereof, can be calculated, as explained herein after.

As indicated herein above, in order to efficiently allow the transceiver units 12A-12G to communicate with one another, the order in which each transceiver units transmits data to its neighboring transceiver units can be determined in accordance with a priority scheme which can be a function of the successful transmission likelihood.

For ease of description the transceiver units 12A-12G in the mesh network is hereinafter defined as nodes in the network. In each instance of data transmission, where data is transmitted from first node to a second node, the first node is referred to hereinafter as the base node, while the second node is referred to as a neighboring node. It is appreciated that since the data is relayed from one node to another, the base node is referred to as a base node only for the instance in which the data is transmitted to the neighboring nodes thereof, while in other instances where the node receives data from another node, the node is referred to as a neighboring node of another base node. In addition, for each data transmission, which includes a destination, such as a device in the smart home system 10 to which it is desired to send a command the controller which controls the targeted device is referred to hereinafter as a destination node.

Reference is now made to FIG. 3, showing a flow chart diagram 50 of a method for managing transmission priority of data transmission from a base node in a mesh network.

When a node receives data from other nodes in the mesh network (block 52) the node is now ready to relay the data to the neighboring nodes thereof and is therefore considered to be a base node. The data received at the base node includes execution data, such as a command to be executed by an electric device in a smart home system. The data further includes destination data, such as an identification of the controller in the smart home system which is configured to control the electric device.

As described here in above, the base node receives the data in a first transmission mode, such as a certain frequency range, while transmitting data in a variety of transmission mode. Thus, the base node transmits the data from the base node to each neighboring nodes, by a dedicated transmission mode for each of the neighboring nodes. The base node transmits the data to each of the neighboring nodes in an order determined in accordance with a transmission rating of each of the neighboring nodes. That is to say, each neighboring node is associated with success rating related to previous transmissions. The base node, thus, transmit the Transmit data to the neighboring node with the highest rating (block 54). If there are other neighboring nodes the base node transmits the data to the neighboring nodes with the highest rating out of all the remaining neighboring nodes (block 56). The transmission is repeated until all the neighboring nodes are sent the data from the base node. As indicated herein above, transmission is carried out with a dedicated mode to each of the neighboring nodes, thus the transmission must be carried out in a subsequent order.

The base node then awaits receiving a receipt acknowledgment from the neighboring nodes (block 58). The receipt acknowledgment is sent by the neighboring nodes only when data sent though the node was successfully delivered to the destination. That is to say, each neighboring node which receives the data from the base node, acts itself as a base node and relays the data to the neighboring nodes thereof. Eventually, the data reaches its destination in the mesh network, such as a controller controlling a device in the smart home system. When the data is received at the destination thereof, the controller sends a receipt acknowledgment to all the neighboring nodes of the controller from which the data was received. It will be understood that the first node to successfully transmit the data to the controller receives the first receipt acknowledgment. Every node which receives a receipt acknowledgment of a certain data transfer, transmits back the receipt acknowledgment to the base node, which originally sent the data to the node. Thus, every node which participated in the data transmission receives a receipt acknowledgment, if the data eventually was received at the destination.

Since however, it is possible that the data relayed between the nodes in the mesh network is successfully transferred to the destination in more than one path, the receipt acknowledgment maybe received at each node form more than one neighboring nodes. Thus, the first neighboring node which send the first receipt acknowledgment is considered the node which was most successful in transmitting the data to the destination.

Thus, when the base node receives the receipt acknowledgment, if the receipt acknowledgment is the first acknowledgment for that particular data transmission (block 60), the rating of the neighboring node from which acknowledgment is received is upgraded (block 62). This way, the next iteration in which a similar data will be received at the base node, with same destination, the base node will prioritize the transmission of the data to the neighboring node which successfully transmitted previous transmissions and which thus has a higher rating.

It is appreciated that each receipt acknowledgment includes an identification to which data transmission the receipt acknowledgment is pertained. For example, each receipt acknowledgment includes the destination from which the acknowledgment was sent, such that the base node can adjust the ratings of the neighboring node for the specific destination.

This rating system precludes the necessity to maintain historical data for each destination, rather a dynamic rating is utilized in which the probability of successful transmission is constantly measured, and modified in accordance with changing conditions in the mesh network, such as physical obstacles between transceiver units in the smart home system.

According to an example, the base node can be configured to receive further receipt acknowledgments from other neighboring nodes (block 64), following the first receipt acknowledgment. Since the other receipt acknowledgments are not the first to be received the rating of the neighboring nodes from which subsequent acknowledgments are received is not modified. According to other examples, the rating can be further modified for subsequent acknowledgments, in accordance with the order in which the receipt acknowledgments are received.

For those neighboring nodes from which no receipt acknowledgment is received the rating is downgraded (block 66). The downgrading of the rating reflects the probability of successful transmission of data to a specific destination. That is to say, the rating system according to an example of the presently disclosed subject matter is configured to rate transmission of data for each neighboring nodes and for each destination in the mesh network. In other words, a neighboring node might have a low rating for transmission of data to one destination while having a higher rating for transmission of data to another destination in the mesh network.

It is appreciated that at the initial stage, while there is no data regarding the probability of successful transmission for each neighboring node, each neighboring node is assigned an equal rating, which is adjusted in response to acknowledgments which are received or not received for each data transmission. With the time, the rating becomes more accurate and the node which is the first to provide a receipt acknowledgment is given a high score relative to other neighboring node. Those neighboring nodes which were not successful at all are downgraded until eventually the rating reaches a predefined low threshold by which the base node stops relaying data to this neighboring node for a specific destination. It is appreciated that since the rating is calculated for each destination separately, the base node might still send data to this neighboring node for data having a different destination.

At the initial stage, when all the neighboring nodes are assigned same initial rating, the transmission priority may be randomly determined, or may be determined in accordance with any other scheme.

In way of example, each neighboring node can be initially assigned rating of 10 for each destination. In each data transmission to a certain destination, a neighboring node which provided the first receipt acknowledgment indicating that the data was reached at the destination, the rating is upgraded by 2 points to 12. For each neighboring node which provided receipt acknowledgment, however not the first acknowledgment, the rating is remained unchanged. For each neighboring node which did not provided a receipt acknowledgment at all, indicating that the data transmission through this node did not reach the destination, the rating is downgraded by 2 points to 8. This way, over time the base node learns the best transmission path for each destination in the smart home system.

It is appreciated that in accordance with an example, the above method is carried out by a processor in each of the node independently of other nodes. Thus, each node self learns the probability of successful data transmission for each destination. At the initial stage, each of the nodes can be fed all the destinations in the mesh network, such as the controllers in the smart home system. Alternatively, each node can be configured to add a destination when a data is received and is directed to a destination which is not yet stored by the node. This way, when a new device is introduce into the smart home system, there is no requirement to notify all the nodes in the system. Rather, when each node receives a data directed to the new device, the new destination is added to the node's memory and is each of the neighboring nodes is assigned an initial predetermined rating for the new destination. The rating is adjusted over time, in accordance with the results of each data transmission to the new destination.

It is appreciated that the above method for managing transmission priority of data transmission can be implemented in any mesh network in which data is transferred from a base node to neighboring node, not only in a smart home system.

Those skilled in the art to which the presently disclosed subject matter pertains will readily appreciate that numerous changes, variations, and modifications can be made without departing from the scope of the invention, mutatis mutandis.

1. A method for managing transmission priority of data transmission from a base node in a mesh network, having a plurality of neighboring nodes, to a destination, the method comprising:
receiving data at the base node said data including execution data and destination data, said destination data being related to the destination of said execution data;
transmitting said data from said base node to each of the neighboring nodes, said transmitting is carried out by a dedicated transmission mode for each of said neighboring nodes in an order determined in accordance with a transmission rating of each of said neighboring nodes, said transmission rating being related to previous transmissions;
receiving at said base node a receipt acknowledgment from a neighboring node which successfully delivered said data to the destination; and
adjusting said transmission rating of said neighboring node in accordance with said delivery acknowledgment.

2. The method according to claim 1 wherein said destination is a controller in said mesh network configured to control a device, and wherein said execution data includes data to be executed by said device.

3. The method according to claim 1 wherein said transmission mode is a frequency, and wherein each of said neighboring nodes is configured to receive said data in a unique frequency with respect to other neighboring nodes.

4. The method according to claim 3 wherein said node is configured to transmit said data to each of said neighboring nodes in a dedicated frequency.

5. The method according to claim 1 wherein said node transmits first said data to one of said neighboring nodes having the highest rating with respect to ratings of other neighboring nodes.

6. The method according to claim 1 wherein said receipt acknowledgment is generated by said destination, when said data reaches said destination.

7. The method according to claim 1 wherein said receipt acknowledgment includes identification of said destination.

8. The method according to claim 1 wherein said adjusting includes upgrading said transmission rating for a neighboring node from which said receipt acknowledgment is received first for each data transmission.

9. The method according to claim 8 wherein said adjusting further includes downgrading said transmission rating for a neighboring node from which no receipt acknowledgment is received.

10. A smart home system for integration in a designated area, the system comprises:
a plurality of transceiver units each of which configured to be disposed in a location around the designated area and to form with one another a mesh communication network, such that each one of said transceiver units has at least one neighboring transceiver unit;
wherein each one of said transceiver units is configured to receive data in a first transmission mode and to transmit said data in at least a second transmitting mode and wherein said at least one neighboring transceiver unit is configured to receive data in said second transmitting mode.

11. The smart home system of claim 10 wherein said transceiver unit includes a first neighboring transceiver unit configured to received data in said second transmission mode, and a second neighboring transceiver unit configured to received data in a third transmission mode, and wherein said transceiver unit is configured to selectively transmit said data in at least said second transmitting mode and said third transmitting mode.

12. The smart home system of claim 10 wherein said first and second transmitting modes are distinct from one another and configured to reduce transmission interference with one another.

13. The smart home system of claim 10 further comprising at least one controller configured for controlling an electric device in said designated area, said controller being configured to receive data from at least one of said transceiver unit.

14. The smart home system of claim 13 wherein said at least one controller is integrated in said electric devices.

15. The smart home system of claim 13 wherein said at least one controller is integrally formed with one of said transducing units.

16. The smart home system of claim 10 wherein each one of said transceiver units is integrated in an electric element mounted in said designated area.

17. The smart home system of claim 16 wherein said electric element is an electric socket or switch.

18. The smart home system of claim 10 further includes a hub configured to exchange data with a remote device.

19. The smart home system of claim 18 wherein said hub is further configured to allow receiving and storing data related to said electric device in a cloud.

20. A smart home system for integration in a designated area, the system comprises:
a plurality of transceiver units each of which configured to be disposed in a location around the designated area and to form with one another a mesh communication network, such that each one of said transceiver units has at least two neighboring transceiver units;
wherein each one of said transceiver units is configured to receive data in a first transmission mode, said data including execution data and destination data, said destination data being related to a destination of said execution data in said mesh communication network;
wherein each one of said transceiver units is further configured to transmit said data to each of said at least two neighboring transceiver units in a transmission mode dedicated for each of said two neighboring transceiver units,
wherein transmission to said two neighboring transceiver units is carried out in an order determined in accordance with a transmission rating of each of said neighboring transceiver units; and
wherein said transmission rating is determined in accordance with previous successful transmission to said destination via said neighboring transceiver units.
